(19) United States
(12) Patent Application Publication
(10) Pub. No.: US 2014/0354395 A1
(43) Pub. Date: Dec. 4, 2014

(54) Thermal Switch for Downhole Device

(71) Applicant: Schlumberger Technology Corporation, Sugar land, TX (US)

(72) Inventor: Julien Tavernier, New Brunswick, NJ (US)

(73) Assignee: Schlumberger Technology Corporation, Sugar land, TX (US)

(21) Appl. No.: 14/289,646

(22) Filed: May 28, 2014

(30) Foreign Application Priority Data
May 30, 2013 (EP) 13305708.3

(51) Int. Cl. H01H 37/00

(52) U.S. Cl. CPC H01H 37/00; H01H 2037/008
USPC 337/300

(57) ABSTRACT

Systems, methods, and devices to protect electronics of a downhole device from overheating in high-temperature wells are provided. In one example, a method includes, while a downhole device is disposed in a wellbore, providing power to first electronics of the downhole device through a switch and providing power to switch control circuitry that controls the switch. The switch may be disposed on a first substrate and the switch control circuitry may be disposed on a second substrate. The method may also include receiving a measurement of a temperature of the downhole device and, when the temperature exceeds a threshold, using the switch control circuitry to open the switch to prevent power from being provided to the first electronics of the downhole device

### BACKGROUND

This disclosure relates to a downhole device that uses a switch, the switch being thermally separated from circuitry that controls the switch, to cut off power to electronic components of the downhole device when a temperature in the downhole device exceeds a threshold.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light.

A variety of downhole devices are used to log, drill, and measure wells for hydrocarbons and other underground materials. A bottom hole assembly (BHA), for example, may be used to drill a well while logging and/or measuring properties of the well while the well is being drilled. Other downhole devices, such as wireline or coiled tubing downhole tools, may be used to log and/or measure properties of the well after it has been drilled. In either case, tool electronics (e.g., logging-while-drilling (LWD) or measurement-while-drilling (MWD) tools) in the downhole devices may fail if exposed to excessive temperatures. These excessive temperatures are more likely to cause problems when the tool electronics are actively consuming power while exposed to high temperatures.

At the same time, oil and gas wells of increasingly higher temperatures and pressures are becoming profitable. In some high-temperature wells, the static temperature of the rock formation may exceed 175° C. and, in some cases, even 200° C. or above. Electronic components that can withstand these temperatures may be highly expensive and/or difficult to obtain. As a result, downhole devices that use such high-temperature electronic components may also be highly expensive and/or may entail considerable design costs. Downhole devices that do not use high-temperature electronic components may overheat if used in high-temperature wells.

To protect electronic components in such high-temperature environments, some downhole devices have used a switch to cut power to electronic components when the ambient temperature exceeds a threshold. Some of these downhole devices, however, may cause false alarms that may needlessly cut power to the electronic components. Others may operate when relatively low amounts of power (e.g., as provided by a battery) are provided to the tool electronics.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Embodiments of the disclosure relate to systems, methods, and devices to protect electronics of a downhole device from overheating in high-temperature wells. In one example, a method includes, while a downhole device is disposed in a wellbore, providing power to first electronics through a switch and providing power to switch control circuitry. The switch may be disposed on a first substrate and the switch control circuitry may be disposed on a second substrate. The method may also include receiving a measurement of a temperature of the downhole device and, when the temperature exceeds a threshold, using the switch control circuitry to open the switch to prevent power from being provided to the first electronics of the downhole device.

In another example, a downhole device may include a downhole measurement tool, a power source configured to supply power to the downhole measurement tool, and thermal switching circuitry. The thermal switching circuitry may cut off power to the downhole measurement tool when a temperature of the downhole device exceeds a threshold. The thermal switching circuitry may employ a switch electrically disposed between the downhole measurement tool and the power source. The switch may open or close based on a switch control signal. The thermal switching circuitry may also include switch control circuitry that is thermally insulated from the switch. The switch control circuitry may generate the switch control signal based on the temperature of the downhole device.

In a third example, a thermal switch module may be disposed in a downhole device and able to cut off power to tool electronics of the downhole device when a temperature of the downhole device exceeds a threshold. The thermal switch module may include a switch disposed on a first substrate and switch control circuitry disposed on a second substrate that is thermally separated from the first substrate. The switch may receive power from a power source and provide the power to the tool electronics based on a switch control signal. The switch control circuitry may measure the temperature of the downhole device and generate the switch control signal to cause the switch to open when the temperature exceeds the threshold.

Various refinements of the features noted above may be undertaken in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of a downhole device that uses a thermal switch to cut off power to electronic components when a temperature exceeds a threshold, in accordance with an embodiment;

FIG. 2 is a block diagram of the thermal switch, which includes a switch on a first substrate and control electronics on a second substrate, in accordance with an embodiment;

FIG. 3 is a schematic circuit diagram of an example of the thermal switch, in accordance with an embodiment;

FIG. 4 is a flowchart of a method for protecting the electronic components of the downhole device using the thermal switch, in accordance with an embodiment; and

FIG. 5 is a schematic circuit diagram of another example of the thermal switch, in accordance with an embodiment.

### DETAILED DESCRIPTION

One or more specific embodiments of the present disclosure will be described below. These described embodiments are examples of the presently disclosed techniques. Additionally, in an effort to provide a concise description of these embodiments, some features of an actual implementation may not be described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would still be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As higher temperature wells become increasingly profitable, there is increased demand for downhole devices that can drill and/or log these wells. This disclosure describes a downhole device that may protect electronic components from overheating in such hostile, high-temperature environments using a thermal switch to cut off power to the electronic components when a temperature exceeds a threshold. The thermal switch may include control circuitry and a switch that are thermally separated from one another. For example, the switch may be disposed on a first substrate (e.g., a higher-power substrate) and the switch control circuitry may be disposed on a second substrate (e.g., a lower-power substrate). In other words, this disclosure uses the term “thermal switch” to refer to a combination of a switch and switch control circuitry that collectively may cut off power based on a temperature reading. It should be understood that the particular switch used in the thermal switch may be switched on or off in any suitable way in response to a control signal.

Thermally separating the control circuitry from the switch—for example, placing the switch and the switch control circuitry on different substrates—may enable the thermal switch to cut off even large amounts of power (e.g. 50 W-600 W), even while reducing false alarms. Namely, when power is coursing through the switch (e.g., when the switch is closed and power is being supplied to the electronic components of the downhole device), the switch may generate substantial waste heat that may be dissipated by the first substrate (e.g., 1 W-10 W). Because the switch control circuitry is disposed on the second substrate, however, the substantial amount of heat dissipated by the first substrate may not cause the switch control circuitry on the second substrate to malfunction, even though the switch may be several degrees hotter (e.g., 2-20° C. or more). As such, the thermal switch may be less likely to cut off power in false alarms, thereby allowing the tool to continue operating and preventing avoidable shutdowns. Moreover, the thermal switch may operate even when a substantial amount of power, such as may be provided by a downhole turbine generator, is provided to the electronic components of the downhole device.

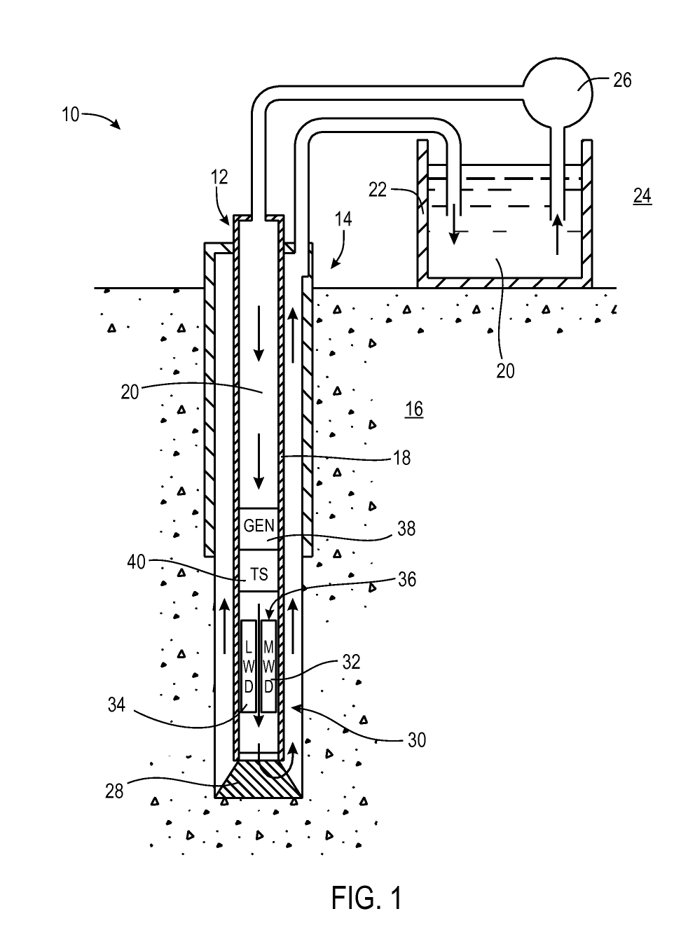

A variety of downhole devices may employ such a thermal switch. As used herein, the term “downhole device” refers to any suitable device used in a downhole environment, and may include, for example, a bottom hole assembly (BHA), a wireline logging tool, a sampling tool, or any other such devices. With this in mind, a downhole device 10, shown in FIG. 1, provides one example of such a downhole device. The downhole device 10 of FIG. 1 includes a drill string 12 used to drill a borehole 14 into a rock formation 16. A drill collar 18 of the drill string 12 encloses the various components of the drill string 12. Drilling fluid 20 from a reservoir 22 at the surface 24 may be driven into the drill string 12 by a pump 26. The hydraulic power of the drilling fluid 20 causes a drill bit 28 to rotate, cutting into the rock formation 16. The cuttings from the rock formation 16 and the returning drilling fluid 20 exit the drill string 12 through an annulus 30. The drilling fluid 20 thereafter may be recycled and pumped, once again, into the drill string 12. In the example of FIG. 1, the downhole device 10 may be referred to as a bottom hole assembly (BHA).

A variety of information relating to the rock formation 16 and/or the state of drilling of the borehole 14 may be gathered while the drill string 12 drills the borehole 14. For instance, a measurement-while-drilling (MWD) tool 32 may measure certain drilling parameters, such as the temperature, pressure, orientation of the drilling device, and so forth. Likewise, a logging-while-drilling (LWD) tool 34 may measure the physical properties of the rock formation 16, such as density, porosity, resistivity, and so forth.

In this disclosure, the electronic components of the downhole device 10, which in this example include the MWD tool 32 and the LWD tool 34, are referred to generally as tool electronics 36. In this disclosure, the term “tool electronics” refers generally to any suitable electrical or electronic components of a downhole device that may be targeted for thermal protection, whether or not specifically associated with a downhole logging, measuring, or sampling tool. In some embodiments, the tool electronics 36 may include more or fewer electronic components and may relate to any downhole tools or electrical components of a downhole device. In certain examples, the tool electronics 36 may represent the operative electronics of the downhole device 10 except for a power source and a thermal switch (e.g., a turbine generator (GEN) 38 and a thermal switch (TS) 40), both of which will be discussed further below. In other examples, the tool electronics 36 may represent a subset of the electronic components of the downhole device 10. For example, the tool electronics 36 may represent just those electronic components of the downhole device 10 not rated beyond a particular temperature rating (e.g., 150° C., 175° C., 200° C., or 230° C., or the like), and therefore possibly susceptible to damage or failure due to overheating if allowed to operate in high temperatures.

The tool electronics 36 and other electronic components of the downhole device 10 may rely on electrical power for their operation. As such, a turbine generator 38 (e.g., a generator coupled to a drilling fluid turbine) may generate electrical power from the hydraulic power of the drilling fluid 20. The turbine generator 38 may provide a generally stable supply of electrical power as the drilling fluid 20 is pumped through the drill string 12. In some examples, the turbine generator 38 may provide a substantial amount of power to the tool electronics 36 (e.g., 50 W-600 W). In other embodiments, electrical power may be supplied to the tool electronics 36 in other ways. In one example, a battery may supply electrical power to the tool electronics 36. In another example, a cable may provide electrical power from the surface.

While the tool electronics 36 are receiving power (e.g., from the turbine generator 38), the tool electronics 36 may be susceptible to damage or failure due to overheating when operating in certain high-temperature conditions. Before continuing, it should be appreciated that a well may have a “static temperature,” which represents the temperature of the drilling fluid 20 when the drilling fluid 20 is not moving around the downhole device 10. Under static conditions, the drilling fluid 20 may be heated over time by the rock formation, which may bring the drilling fluid 20 up to the temperature of the rock formation. The rock formation in a “high-temperature well” may have a static temperature of about 150° C. or beyond. A “circulating temperature” of the well may be effectively lower on the downhole device 10, however, because as lower-temperature drilling fluid 20 is pumped down into the well, the lower-temperature drilling fluid 20 may draw away some of the heat on the tool electronics 36 and/or other electronic components of the downhole device 10.

When the tool electronics 36 are not receiving power and are therefore not operating, the tool electronics 36 may be able to withstand substantially higher temperatures without damage or failure. In some cases, for example, it is believed that when the tool electronics 36 are capable of operating in temperatures of up to 175° C., the tool electronics 36 may be capable of surviving much higher temperatures (e.g., 200° C., 215° C., or even 230° C. or beyond) as long as the tool electronics 36 are not operating—that is, not receiving power. When the drilling fluid 20 is not circulating, the drilling fluid 20 does not drive the turbine generator 38. As a result, the turbine generator 38 does not generate electrical power. Accordingly, the tool electronics 36 will not be receiving power from the turbine generator 38 when the drilling fluid 20 is not circulating. Since, at this point, the drilling fluid 20 is not circulating, the temperature of the tool electronics may increase toward the static temperature of the well, which could be much higher than the tool electronics 36 could tolerate if supplied power from the turbine generator 38. After the drilling fluid 20 begins to circulate again, the circulating drilling fluid 20 may, over time, reduce the temperature of the tool electronics 36 to a temperature at which the tool electronics 36 reliably operate. Until the tool electronics 36 reach this threshold temperature, a thermal switch (TS) 40 may prevent the tool electronics 36 from receiving power generated by the turbine generator 38.

Specifically, even though the tool electronics 36 may not be composed of electrical components rated for high-temperature wells, the thermal switch (TS) 40 may protect the tool electronics 36 even when the downhole device 10 of FIG. 1 is used in a high-temperature well. Specifically, the thermal switch 40 may identify when a temperature of the downhole device 10 exceeds a threshold associated with a maximum temperature for which the tool electronics 36 can reliably operate. The thermal switch 40 then may cut off power to the tool electronics 36 when the temperature exceeds the threshold, thereby protecting the tool electronics 36 from damage or failure under high-temperature conditions. In this way, in some examples, the tool electronics 36 may use electrical components rated for temperatures up to 150° C. or 175° C., even though the static temperature of the well may be much higher (e.g., 175° C., 200° C., 215° C., or even 230° C. or beyond). This may allow even tool electronics 36 designed for lower-temperature wells to be used in higher-temperature wells without damage or failure.

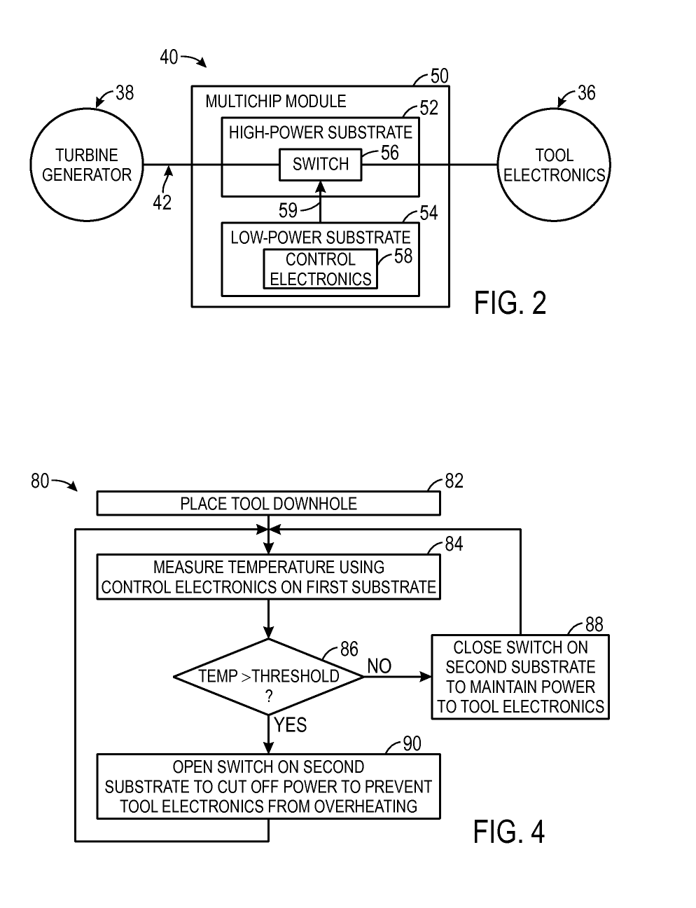

Moreover, the thermal switch 40 may reduce the incidence of false alarms, even while carrying relatively large amounts of electrical power (e.g., from the turbine generator 38), by keeping a switch that cuts off power to the tool electronics 36 thermally separated from switch control circuitry. FIG. 2 provides one example of the thermal switch 40. As seen in FIG. 2, the turbine generator 38 provides power over a bus 42 through the thermal switch 40 to the tool electronics 36. The thermal switch 40 may have a variety of implementations. The thermal switch 40 may be contained within a single multichip module (MCM) 50, as shown in the example of FIG. 2. The MCM 50 is a sealed enclosure to protect the circuitry of the thermal switch 40 from dust and other contaminants. In other embodiments, the thermal switch 40 may be made up of more than one MCM. Moreover, it should be appreciated that the thermal switch 40 may be used to cut power to the tool electronics 36 in any suitable downhole device 10. As such, although the example of FIG. 2 illustrates power supplied by a turbine generator 38, power may be provided by any suitable power source, including a battery or a source external to the downhole device 10 (e.g., an electrical power generator at the surface).

The MCM 50 of FIG. 2 may include a sealed housing surrounding two substrates 52 and 54, upon which electrical components of the thermal switch 40 are disposed. The MCM 50 may include a first substrate 52 and a second substrate 54. These substrates 52 and 54 may, in various examples, have similar or different characteristics. In the example of FIG. 2, the first substrate 52 may be a higher-power substrate that can dissipate waste heat from electrical components more quickly than the second substrate 54. The second substrate 54 may be a lower-power substrate that dissipates heat more slowly than the first substrate 52. Consequently, the first substrate 52 may set electrical components farther apart from one another and may use wide tracks to carry electricity to and from the electrical components disposed on the first substrate 52. Although this may allow heat to dissipate more quickly from electrical components disposed on the first substrate 52, potential space constraints on the first substrate 52 may make including electrical components of the thermal switch 40 on the first substrate 52 impracticable or expensive. By contrast, when the second substrate 54 is a lower-power substrate, the second substrate 54 may set electrical components more closely to one another and may use narrower tracks to carry electricity and electrical signals to and from the electrical components on the second substrate 54. In addition, the constraints on the first substrate 52 may include which type of metals may be used for electrical components that are disposed on the first substrate 52. Specifically, metal composing the backside of these electrical components may be selected to be compatible with metal of the first substrate 52—over time, the higher temperatures of the first substrate 52 may create weaker alloys if the metals used in the electrical components on the first substrate 52 are not selected to be compatible.

In the example of FIG. 2, the first substrate 52 may include a switch 56 that can carry the power flowing over the bus 42. The first substrate 52 may be selected to sufficiently dissipate waste heat that is emitted by the switch 56 when the switch 56 is carrying power. The switch 56 may be any suitable switch capable of carrying the amount of power between the power source (e.g., the turbine generator 38) and the tool electronics 36. The second substrate 54 may include lower-power switch control circuitry 58 may be disposed on the second, lower-power substrate 54. The switch control circuitry 58 may generate a switch control signal 59 to cause the switch 56 to be open or closed. When closed, the switch 56 may enable power to flow across the bus 42 from the turbine generator 38 to the tool electronics 36. The switch control circuitry 58 may include components that are smaller than the switch 56 and/or that may dissipate less heat than the switch 56. Because the switch control circuitry 58 are thermally separated from the switch 56—in this case by being located on a separate substrate 54 from the substrate 52—the switch control circuitry 58 may operate in a manner largely independent of the heat given off by the switch 56. As a result, the switch control circuitry 58 may be less likely to needlessly switch off the switch 56, while being able to operate in high-temperature wells.

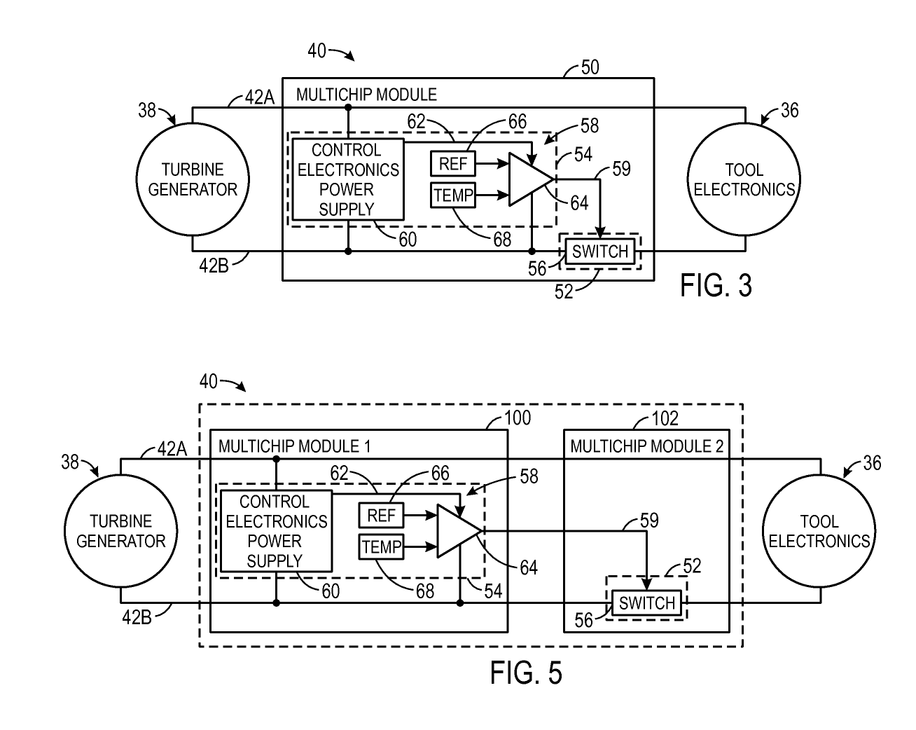

A schematic circuit diagram illustrating the thermal switch 40 appears in FIG. 3. In the example of FIG. 3, the turbine generator 38 provides power to the tool electronics 36 via a direct current (DC) voltage difference over a positive bus 42A and a negative bus 42B. As noted above, the turbine generator 38 is illustrated by way of example, and any other suitable power source may supply power to the tool electronics 36. For example, a battery in the downhole device 10 or a generator at the surface supplied from the surface may supply power additionally or alternatively to the turbine generator 38. The switch 56 may be located on the positive bus 42A, the negative bus 42B, or there may be two switches 56 each located on a different one of the positive bus 42A and the negative bus 42B. The use of two switches 56 in such an alternative embodiment may provide greater redundancy to protect the tool electronics 36, but might result in a greater likelihood of a false alarm. In any case, when the switch 56 is open, power does not flow to the tool electronics 36.

In some embodiments, the switch control circuitry 58 on the second substrate 54 may generate the switch control signal 54 substantially independent of the heat dissipated from the switch 56. Indeed, the switch control circuitry 58 may be located on the second substrate 54 while the switch 56 may be located on the first substrate 52. In other examples, any other suitable form of thermal separation may thermally separate the switch 56 and the switch control circuitry 58. The switch control circuitry 58 may include, for example, a control circuitry power supply 60 that may take in some operating power the positive bus 42A and negative bus 42B. The control circuitry power supply 60 may generate an operating voltage 62 for a comparator 64 as well as other components of the switch control circuitry 58 not expressly shown in FIG. 3, such as a temperature sensor or reference voltage circuitry. In the example of FIG. 3, the comparator 64 may receive the operating voltage 62 as an upper voltage and may receive a lower voltage directly from the negative bus 42B. The comparator 64 may compare a threshold reference voltage 66, which indicates a threshold temperature, and a temperature indication voltage 68, which indicates a temperature of the downhole device 10. When the temperature indication voltage 68 exceeds the threshold reference voltage 66, the control signal 59 may cause the switch 56 to open. Otherwise, the comparator 64 may generate the control signal 59 to cause the switch 56 to be closed. The threshold temperature may be any suitable temperature at or beneath a maximum temperature at which the tool electronics 36 can reliably operate. For instance, if the electrical components of the tool electronics 36 are rated for a maximum temperature of 175° C., the threshold reference voltage 66 may be selected to cut off power when the temperature indication voltage 68 indicates a temperature of 175° C.

The temperature indication voltage 68 may be received from any suitable temperature sensor in any suitable location in the downhole device 10. In some examples, the temperature sensor that provides the temperature indication voltage 68 may be located in the switch control circuitry 58 on the second substrate 54. In other examples, the temperature sensor that supplies the temperature indication voltage 68 may be located elsewhere in the downhole device 10. For instance, the temperature sensor that provides the temperature indication voltage 68 may be amid the tool electronics 36. Because the temperature sensor that provides the temperature indication voltage 68 may be thermally separated from the switch 56, and the switch 56 may generate enough waste heat to cause the ambient temperature at the switch to be more than 5-15° C. higher than elsewhere in the downhole device 10, the temperature indication voltage 68 may indicate a temperature more than 10° C. cooler than the switch 56 in some embodiments.

As mentioned above, the tool electronics 36 may use electrical components rated for any suitable maximum temperature. By way of example, in one embodiment, the tool electronics 36 may use electrical components rated for operation up to 150° C., 175° C., 200° C., or 230° C. or beyond. The threshold used by the thermal switch 40 may be selected accordingly. To be able to cut off power to the tool electronics 36 around the maximum temperature for which the electrical components of the tool electronics 36 are rated, the electrical components of the thermal switch 40 may have a higher temperature rating. Indeed, in some embodiments, each of the electrical components of the thermal switch 40 may be rated to withstand temperatures of at least 150° C., at least 175° C., at least 200° C., or even at least 230° C. or beyond. In any case, the electrical components of the thermal switch 40 may be rated to operate in higher maximum temperatures than the electrical components of the tool electronics 36. It further may be noted that power to the switch control circuitry 58 may continue to be supplied while the turbine generator 38 is supplying power. Thus, the various electrical components of the thermal switch 40 may be selected to be capable of operating in a maximum temperature that may be expected in the well in which the downhole device 10 will be used.

A downhole device 10, using the thermal switch 40, may be operated inside a high-temperature well even when the tool electronics 36 are not composed of electrical components that are rated for the maximum temperatures of the well. For example, as seen in a flowchart 80 of FIG. 4, the downhole device 10 may be placed downhole into a well (block 82). The downhole device 10 may be a bottom hole assembly (BHA) that is used to drill the well and provide logging-while-drilling (LWD) and/or measurement-while-drilling (MWD), in the manner illustrated in FIG. 1. Additionally or alternatively, the downhole device 10 may be a downhole device conveyed in any other suitable way, and thus may be a wireline or coiled tubing downhole tool or a downhole sampling tool. Indeed, any suitable downhole device 10 may be placed downhole into a well using any suitable means of conveyance.

In any case, a power source may supply power to the tool electronics 36 through a thermal switch 40. The power source may be the turbine generator 38, a battery, or a power generation device at the surface, or any other suitable power supply. The tool electronics 36 of the downhole device 10 may be protected from excessive temperatures by the thermal switch 40. Specifically, the switch control circuitry 58 of the thermal switch 40 may detect a temperature of the downhole device 10 (block 84). For instance, the control electronics 54 may receive an indication of a temperature at the second substrate 54, a temperature at the tool electronics 36, and/or a temperature in another location in the downhole device 10. The temperature that is detected may be thermally separated from the switch 56 on the first substrate 52.

While the temperature remains beneath a threshold (decision block 86), the switch control circuitry 58 may generate the control signal 59 to cause the switch 56 to remain closed, thereby maintaining power to the tool electronics 36 (block 88). When the temperature exceeds the threshold (decision block 86), the switch control circuitry 58 of the thermal switch 40 may generate the control signal 59 to open the switch 56 to cut off power to the tool electronics 36, thereby reducing or preventing damage or failure of the tool electronics 36 due to overheating (block 90).

As noted above, the switch control circuitry 58 is thermally separated from the switch 56. Since the switch 56 may generate substantial waste heat, which could cause the switch control circuitry 58 to fail or generate false alarms, thermally separating these two elements may allow the switch control circuitry 58 to operate under high temperature conditions while reducing the likelihood of false alarms. In an example shown in FIG. 5, the thermal switch 40 may achieve this thermal separation using two separate multichip modules (MCMs) 100 and 102. In the example of FIG. 5, a first MCM 100 includes the switch control circuitry 58 disposed on the second substrate 54. The switch control circuitry 58 may be substantially the same as described above with reference to FIGS. 2 and 3. A second MCM 102 of FIG. 5 may include the switch 56 on the first substrate 52. Alternatively, any other suitable circuit design that thermally separates the switch control circuitry 58 from the switch 56 may be employed.

The specific embodiments described above have been shown by way of example, and it should be understood that these embodiments may be susceptible to various modifications and alternative forms. It should be further understood that the claims are not intended to be limited to the particular forms disclosed, but rather to cover modifications, equivalents, and alternatives falling within the spirit and scope of this disclosure.

1. A method comprising:
while a downhole device is disposed in a wellbore:
providing power to:
first electronics of the downhole device via a switch disposed on a first substrate in the downhole device; and
switch control circuitry disposed on a second substrate in the downhole device;
receiving a measurement of a temperature of the downhole device in the switch control circuitry; and
when the temperature exceeds a threshold, using the switch control circuitry to open the switch to prevent power from being provided to the first electronics of the downhole device.

2. The method of claim 1, wherein the method is performed while the downhole device is disposed in the wellbore, wherein the downhole device comprises a bottom hole assembly used in a logging-while-drilling (LWD) operation, a measurement-while-drilling (MWD) operation, or both the logging-while-drilling (LWD) operation and the measurement-while-drilling (MWD) operation.

3. The method of claim 1, wherein the method is performed while the downhole device is disposed in the wellbore, wherein the downhole device is conveyed via a conveyance not used in logging-while-drilling (LWD) or measurement-while-drilling (MWD).

4. The method of claim 1, wherein providing power to the first electronics comprises providing power to substantially all electronic circuitry of the downhole device except for electronics associated with the switch.

5. The method of claim 1, wherein providing power to the first electronics comprises providing power to:
one or more logging-while-drilling (LWD) tools;
one or more measurement-while-drilling (MWD) tools; or
any combination thereof.

6. The method of claim 1, wherein the power is provided to the first electronics using:
an electrical generator disposed in the downhole device;
a battery disposed in the downhole device; or
a power source at a surface of the wellbore; or
any combination thereof.

7. The method of claim 1, wherein the measurement of the temperature is received from a temperature sensor disposed on the second substrate.

8. The method of claim 1, wherein the measurement of the temperature is received from a temperature sensor disposed amid the first electronics.

9. The method of claim 1, wherein the threshold is greater than or equal to 150 degrees C.

10. The method of claim 1, wherein the measurement of the temperature is lower by more than 10 degrees C. than a temperature of the switch.

11. A downhole device comprising:
a downhole measurement tool;
a power source configured to supply power to the downhole measurement tool; and
thermal switching circuitry configured cut off power to the downhole measurement tool when a temperature of the downhole device exceeds a threshold, wherein the thermal switching circuitry comprises:
a switch electrically disposed between the downhole measurement tool and the power source, wherein the switch is configured to open or close based on a switch control signal; and
switch control circuitry configured to generate the switch control signal based on the temperature of the downhole device, wherein the switch control circuitry is thermally insulated from the switch.

12. The downhole device of claim 11, wherein the power source comprises an electrical generator configured to generate power using drilling fluid flowing through the downhole device.

13. The downhole device of claim 11, wherein the control circuitry of the thermal switching circuitry is configured to withstand higher temperatures when the thermal switching circuitry is supplied with power than the downhole measurement tool when the downhole measurement tool is supplied with power.

14. The downhole device of claim 11, wherein the thermal switching circuitry is contained in a single multi-chip module (MCM) comprising two substrates, wherein the switch is disposed on a first of the substrates and the control circuitry is disposed on a second of the substrates.

15. The downhole device of claim 11, wherein the thermal switching circuitry is contained in two multi-chip modules (MCMs) each comprising one substrates, wherein the switch is disposed on a first of the substrates in a first of the MCMs and the control circuitry is disposed on a second of the substrates in a second of the MCMs.
